(19) United States
(12) Patent Application Publication
(10) Pub. No.: US 2013/0087680 A1
(43) Pub. Date: Apr. 11, 2013

(54) HEAVY MACHINERY SUPPORT STAND

(71) Applicants: BRIAN EUGENE AUSTIN, Victorville, CA (US); John Fenton, Victorville, CA (US); Donald Dombrowski, Victorville, CA (US); Viorel Soca, Victorville, CA (US)

(72) Inventors: BRIAN EUGENE AUSTIN, Victorville, CA (US); John Fenton, Victorville, CA (US); Donald Dombrowski, Victorville, CA (US); Viorel Soca, Victorville, CA (US)

(21) Appl. No.: 13/269,730

(22) Filed: Oct. 10, 2011

(51) Int. Cl. F16M 5/00; F16M 11/20

(52) U.S. Cl. 248/676; 248/188.1

(57) ABSTRACT

A support stand for supporting raised heavy machinery is disclosed. The support frame may include a top support frame including concave sidewalls. Box frames may be stackable intermediate the top support frame and a base. The box frames may be of varying height profiles.

### BACKGROUND OF THE INVENTION

The present invention generally relates to support apparatus, and more particularly, to a heavy machinery support stand.

Some heavy machinery, for example, aircraft, undergoes periodic maintenance or disassembly requiring that the machinery be raised off the ground. One conventional manner of elevating machinery includes stacking railroad ties so that the machinery can be raised and placed onto the stacks of ties. The railroad ties are stacked manually, typically taking a crew of five or more a week to complete, causing expense and wasted time, as well as an environmental impact when the ties are disposed. Additionally, railroad ties are generally uniform in thickness and generally convex or flat on their top surface potentially causing instability in carrying a machine with rounded bottom surfaces and inflexibility in adjusting the height of the stack.

As can be seen, there is a need for a support stand that provides quick assembly, stability, and height flexibility in supporting heavy machinery.

### SUMMARY OF THE INVENTION

In one aspect of the present invention, a support stand comprises a base; a plurality of rigid, projecting frame members attached to the base; a support frame disposed over the projecting frame members; and a pair of concave sidewalls disposed on opposite sides of the support frame.

In another aspect of the present invention, a support stand comprises a base; a top support frame disposed over the base, the support frame including two or more concave sidewalls; and one or more stackable box frames disposed intermediate the base and the top support frame.

These and other features, aspects and advantages of the present invention will become better understood with reference to the following drawings, description and claims.

### BRIEF DESCRIPTION OF THE DRAWINGS

FIG. 1 is a side view of a plurality of support stands in use according to an exemplary embodiment of the present invention;

FIG. 2 is a perspective view of a support stand according to an exemplary embodiment of the present invention;

FIG. 3 is an end view of the support stand of FIG. 2;

FIG. 4 is a perspective view of an exemplary foot support usable by the support stand of FIG. 2;

FIG. 5 is an exploded view of the support stand of FIG. 2;

FIG. 6 is a broken enlarged cross-sectional view of a peg and hole joint taken along the line 6-6 of FIG. 3; and

FIG. 7 is a top view of the plurality of support stands according to the exemplary use shown in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Various inventive features are described below that can each be used independently of one another or in combination with other features.

Broadly, embodiments of the present invention generally provide a support stand for heavy machinery. In one exemplary application, aspects of the following disclosure may be used to support an idle aircraft. However, it will be understood that aspects of the following disclosure may also be useful to support other heavy machines that need to be propped up for maintenance or disassembly. It may be appreciated that aspects of the following disclosure may provide a sturdy support and a structure that is accommodating to rounded bodies. The present invention may also provide quick assembly and interchangeability between elements that may further provide adjustable height of the support machine above the ground.

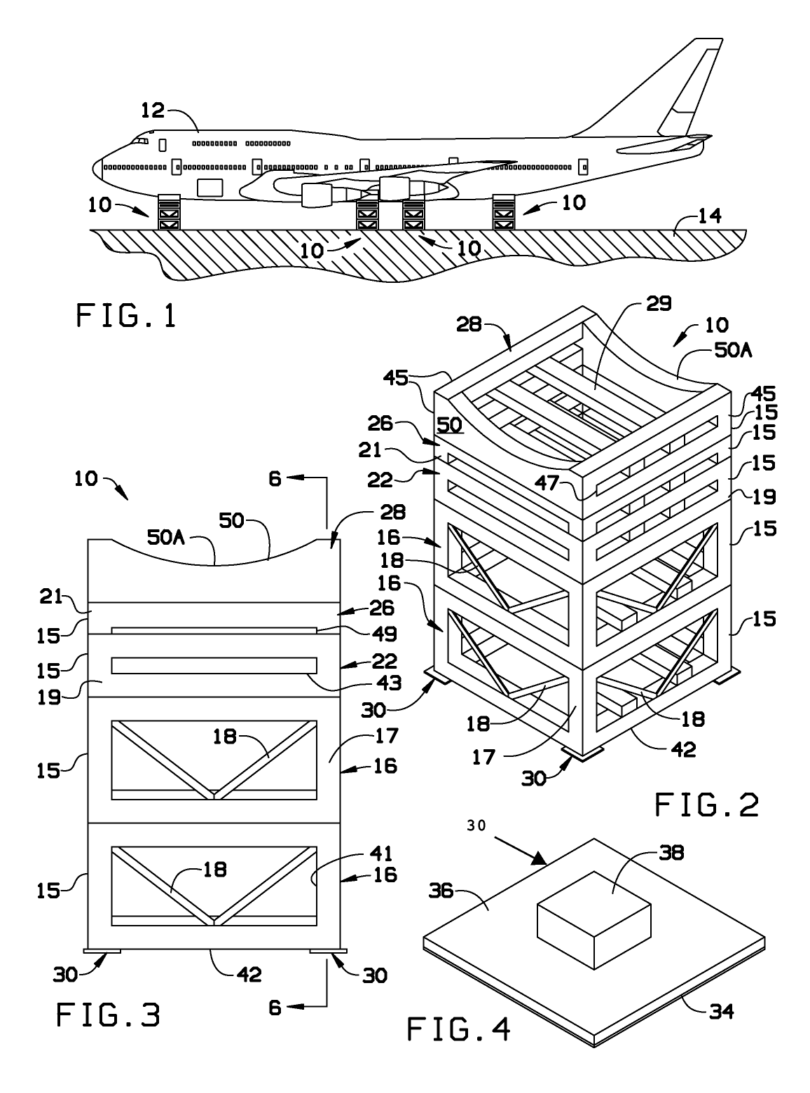

Referring to FIGS. 1 and 7, a load 12, for example, an aircraft is shown supported by a plurality of support stands 10 over a ground surface 14. The support stands 10 may be positioned under various points of the load 12 to provide stable, balanced distribution of the load 12 over the surface 14.

Referring to FIGS. 2-3 and 5, an exemplary embodiment of the support stand 10 is shown. The support stand 10 may include a top support frame 28 one or more box frames 15, and a base 42. The top support frame 28 may include one or more concave sidewalls 50. The top support frame 28 and the box frames 15 may be configured to vertically project from the base 42. The top support frame 28 and the box frames 15 may be configured for stackability upon each other with the top support frame 28 being atop all of the box frames 15 and the box frames 15 intermediate the top support frame 28 and the base 42. It will be understood that whichever of the box frames 50 that is the lowest may be considered the base 42.

The top support frame 28 may be adapted to cradle a surface of the load 12. The top support frame 28 may include front and back walls 45 and sidewalls 50. The sidewalls 50 may include a generally downward curved surface 50a extending between the front and back walls 45. The front and back walls 45 may define a slot 47 included within respective walls. One or more support beams 29 may be disposed to extend between the two slots 47.

In one aspect, the support stand 10 may be configured to provide an adjustable height and adjustable weight support while providing relatively lightweight assembly/disassembly of the stand. For example, the box frames 15 may be configured of varying profiles and support structures. The following box frames 15 will be described for sake of illustration as box frames 16, 22, and 26 with respect to varying features shown. However, it will be understood that other configurations of box frames 15 may be contemplated within the scope of the ensuing disclosure. In general, the box frames 16, 22, and 26 may include support beams 29 disposed horizontally along a bottom of respective box frames.

The box frame 16 may be configured for general purpose stacking to provide the primary height needs to support a load off the ground. In the exemplary embodiment shown, two box frames 16 are stacked upon each other to create a primary height of the support stand 10. The box frame 16 may include sidewalls 17 defining generally rectangular framing 41. A truss structure 18, for example, one or more diagonal beams may be attached within the framing 41 of the sidewalls 17. In one exemplary embodiment, a pair of diagonal beams 18 may be configured to extend in a V-shape between two corners of the sidewall 17 framing 41.

The box frame 22 may be configured with a lower profile than the box frame 16 to provide flexibility in the overall height of the support stand 10. The box frame 22 may include sidewalls 19 that define a rectangular framing 43.

The box frame 26 may be configured with a lower profile than the box frame 22 to provide fine tuning in adjusting the overall height of the support stand 10. The box frame 26 may include sidewalls 21 that may define an open-bottom framing 49. The lack of a bottom edge of the frame 49 may provide a decreased profile while the support beams 29 may continue to provide support.

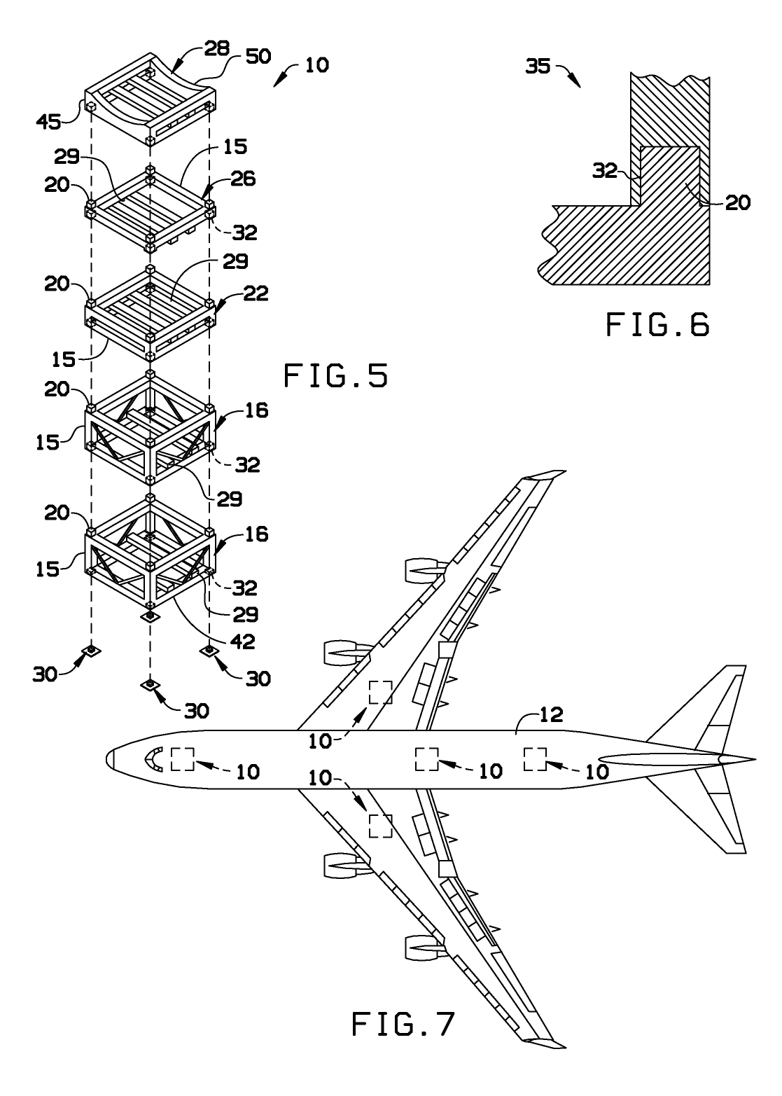

In one aspect, referring to FIGS. 4 and 6, the box frames 15 may be configured for interchangeable stackability. A peg and hole system 35 may be employed on corners of respective box frames 15 and the top support frame 28. A peg 20 may be attached to a top surface of the box frames 15. A female mating hole 32 adapted to receive the peg 20 may be formed on a bottom surface of respective box frames 15 and the top support frame 28. A base peg 38 attached to the top surface 36 of a rectangular foot 34 may be configured to attach to the female mating hole 32 of each corner of the lowest box frame 15.

Referring back to FIG. 5, an exemplary assembly of the support stand 10 is shown with the tallest box frames 16 stacked on the bottom, and box frames 22 and 26 stacked in order of decreasing height. However, it will be understood that in some embodiments, the box frames 15 may be stacked without regard to height. Additionally, some embodiments may omit use of any of the box frames 15 depending on the application. When assembled, the pair of curved surfaces 50a on the top support frame 28 provide a cradle for loads with rounded surfaces, for example, aircraft. However, it will be understood that other exemplary embodiments may employ flat top edges instead of the curved surfaces 50a to support loads with flat surfaces.

It should be understood, of course, that the foregoing relates to exemplary embodiments of the invention and that modifications may be made without departing from the spirit and scope of the invention as set forth in the following claims.

What is claimed is:

1. A support stand, comprising:
a base;
a plurality of rigid, projecting frame members attached to the base;
a support frame disposed over the projecting frame members; and
a pair of concave sidewalls disposed on opposite sides of the support frame.

2. The support stand of claim 1, wherein the concave sidewalls are adapted to receive a substantially round portion of a piece of machinery.

3. The support stand of claim 2, further comprising a truss structure attached to the plurality of vertically projecting frame members.

4. The support stand of claim 2, wherein the plurality of projecting frame members are made from steel or a metallic alloy.

5. A support stand, comprising:
a base;
a top support frame disposed over the base, the support frame including two or more concave sidewalls; and
one or more stackable box frames disposed intermediate the base and the top support frame.

6. The support stand of claim 5, further comprising:
a peg and hole system adapted to receive adjacent box frames stacked upon each other.

7. The support stand of claim 5, further comprising peg feet attached to a bottom of the base.

8. The support stand of claim 5, wherein the box frames include support beams.

9. The support stand of claim 7, wherein the one or more box frames include sidewalls wherein the sidewalls of one of the one or more box frames is taller than the sidewalls of another of the one or more box frames.

10. The support stand of claim 9, wherein the one or more box frames are adapted to interchangeably stack atop one another.
